(19) United States
(12) Patent Application Publication
(10) Pub. No.: US 2015/0048173 A1
(43) Pub. Date: Feb. 19, 2015

(54) METHOD OF PROCESSING AT LEAST ONE OBJECT IN IMAGE IN COMPUTING DEVICE, AND COMPUTING DEVICE

(71) Applicant: Samsung Electronics Co., Ltd., Suwon-si (KR)

(72) Inventors: Nitin UPADHYAY, Bangalore (IN); Arabinda VERMA, Bangalore (IN)

(21) Appl. No.: 14/310,379

(22) Filed: Jun. 20, 2014

(30) Foreign Application Priority Data
Aug. 13, 2013 (IN) 3599/CHE/2013
Feb. 18, 2014 (KR) 10-2014-0018660

(51) Int. Cl. G06K 9/62

(52) U.S. Cl. CPC G06K 9/6288
USPC 239/1; 382/103

(57) ABSTRACT

A method of processing at least one object in an image in a computing device and the computing device is provided. The method includes detecting at least one smell signal associated with at least one object in the image and performing processing by associating the detected at least one smell signal with the corresponding at least one object in the image.

### CROSS-REFERENCE TO RELATED APPLICATION(S)

This application claims the benefit under 35 U.S.C. §119(a) of an Indian patent application filed on Aug. 13, 2013 in the Indian Patent Office and assigned Serial number 3599/CHE/2013, and a Korean patent application filed on Feb. 18, 2014 in the Korean Intellectual Property Office and assigned Serial number 10-2014-0018660, the entire disclosures of each of which is hereby incorporated by reference.

### TECHNICAL FIELD

The present disclosure relates to a method of processing at least one object in an image in a computing device, and the computing device.

### BACKGROUND

With the development of technology, an image capturing device can provide many extra functions like recording sound, audio, and video in addition to the basic function of capturing an image. A current digital image file stores hidden metadata such as geolocation, and the geolocation includes altitude, longitude, latitude, and temperature.

The fields of photography have continuously striven to develop more advanced and sophisticated techniques for accurately capturing images or events and realistically reproducing them. In order to accurately reproduce captured events, it is necessary to provide stimuli related to other senses beyond sound (audio) and vision (video).

The sense of smell contributes greatly to the way a user experiences life. Smells may also be evocative of a good experience in the past. It is therefore highly desirable to convey smells along with the visual (and optionally audio) stimuli of a photograph. Furthermore, capturing smells and tastes at the point of capturing a photograph would be desirable since the smells and tastes are then able to enhance the ability of the photograph to serve as a memento of the occasion.

Several conventional technologies have been proposed which allow a user to record smells in environments or spots while capturing images. However, these technologies do not process odor or smell information in association with digital images.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method of processing at least one object in an image in a computing device, and the computing device.

Additional aspects will be set forth in part in the description which follows and, in part, will be apparent from the description, or may be learned by practice of the presented various embodiments.

In accordance with an aspect of the present disclosure, a method of processing at least one object in an image in a computing device is provided. The method includes detecting at least one smell signal associated with the at least one object in the image and performing processing by associating the detected at least one smell signal with the at least one object in the image.

The detecting of the smell signal associated with the at least one object in the image may include detecting the at least one object in the image and receiving the at least one smell signal associated with the detected at least one object through a sensor.

The performing the processing may include converting the at least one smell signal into at least one streamlined signal, filtering the at least one streamlined signal and analyzing an intensity of the filtered at least one streamlined signal, and generating a digital classification pattern of the at least one smell signal based on the intensity of the filtered at least one streamlined signal.

The performing of the processing may further include determining an index associated with the generated digital classification pattern by mapping the generated digital classification pattern to a predefined digital classification pattern.

The performing of the processing may include generating a geolocation digital pattern corresponding to a geolocation of the at least one object in the image.

The method may further include generating a digital image file by combining the generated geolocation digital pattern corresponding to a geolocation of the at least one object with the index associated with the generated digital classification pattern of the at least one smell signal.

In accordance with another aspect of the present disclosure, a method of processing at least one object in an image in a computing device is provided. The method includes displaying the image containing the at least one object, and dispensing at least one smell signal associated with the at least one object.

The method may further include detecting a user gesture on the at least one object, and adjusting the dispensing of the at least one smell signal associated with the at least one object in response to the detection of the user gesture.

The method may further include displaying geolocation information associated with the at least one object.

In accordance with another aspect of the present disclosure, a computing device is provided. The computing device includes a display, a sensor configured to receive at least one smell signal, a memory configured to store at least one instruction, and a processor configured to execute the at least one instruction stored in the memory, wherein the processor, in response to the at least one instruction stored in the memory, is further configured to detect the at least one smell signal associated with at least one object in an image and to perform processing by associating the detected at least one smell signal with the at least one object in the image.

In accordance with another aspect of the present disclosure, a computing device is provided. The computing device includes a display, a smell dispenser configured to dispense a smell signal, a memory configured to store at least one instruction, and a processor configured to execute the at least one instruction stored in the memory, wherein, in response to the at least one instruction, the processor is further configured to display an image containing at least one object and to dispense at least one smell signal associated with the at least one object.

In accordance with another aspect of the present disclosure, a non-transitory computer-readable recording medium has recorded thereon a program for executing a method of processing at least one object in an image in a computing device on a computer.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will become apparent from the following description taken in conjunction with the accompanying drawings, in which:

FIG. 1 is a block diagram of a computing device according to an embodiment of the present disclosure;

FIG. 2 is a block diagram of a module for processing at least one object in an image according to an embodiment of the present disclosure;

FIG. 3 illustrates a method of processing at least one object in an image according to an embodiment of the present disclosure;

FIG. 4A illustrates a method of processing at least one object in an image according to an embodiment of the present disclosure;

FIG. 4B illustrates an example of a generated digital image file format according to an embodiment of the present disclosure;

FIG. 5 is a flowchart of a method of dispensing a smell of an object in an image according to an embodiment of the present disclosure;

FIG. 6 is a flowchart of a method of viewing a stored captured image and dispensing a smell of an object in the captured image according to an embodiment of the present disclosure;

FIG. 7 illustrates a method of incorporating a smell of one or more objects in an image and a geolocation corresponding to associated objects into the image while capturing the image according to an embodiment of the present disclosure;

FIG. 8 illustrates a method of displaying a captured image shown in FIG. 7 and dispensing a smell of an object associated with the captured image according to an embodiment of the present disclosure; and

FIG. 9 illustrates a method of viewing a captured image and dispensing a smell of an object associated with the captured image based on a user's gesture according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiment of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

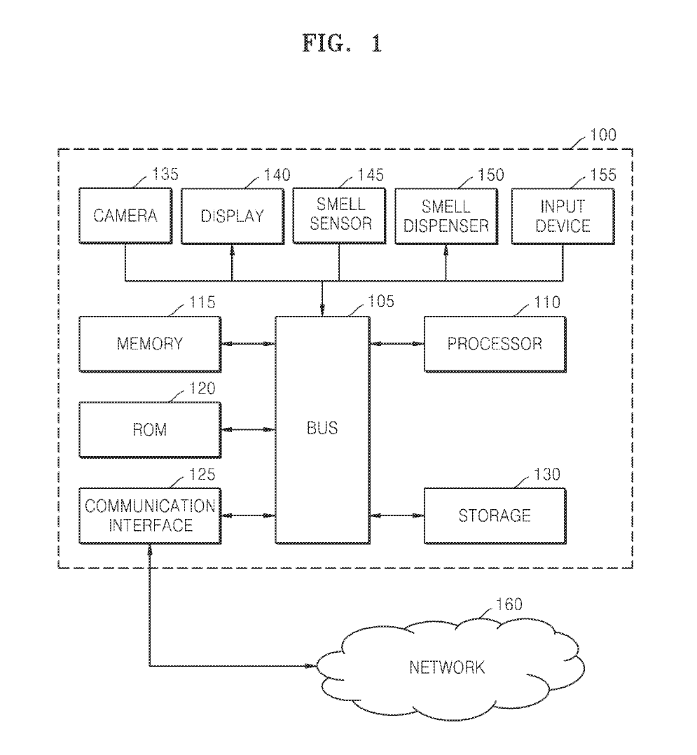

FIG. 1 is a block diagram of a computing device according to an embodiment of the present disclosure.

Referring to FIG. 1, the computing device 100 may include a digital camera, a mobile device incorporating a camera, a camcorder, a smartphone, a tablet, an electronic gadget, or any other device capable of capturing and displaying an image and dispensing a smell of an object in the image. For capturing image(s), any conventional methods known to one of ordinary skill in the art may be used.

Throughout the specification, the terms an “image” and a “digital image” are used interchangeably without distinguishing one from the other.

In the specification, the terms “odor”, “smell”, and “aroma” are also used interchangeably.

Referring to FIG. 1, the computing device 100 may include a bus 105, a processor 110, a memory 115, Read-Only Memory (ROM) 120, a communication interface 125, a storage 130, a camera 135, a display 140, a smell sensor 145, a smell dispenser 150, and an input device 155.

The bus 105 may be a medium for data communication between components within the computing device 100.

The processor 110 is coupled to the bus 105 and processes information, and in particular, at least one object in an image. The processor 110 may be configured to detect at least one object in a captured image and a smell signal associated with the detected object, and associate the object with the smell signal corresponding to the object for processing. Furthermore, in one embodiment, when an image containing an object having smell information stored therein is displayed, the processor 110 may perform processing so that a smell signal associated with the object is dispensed.

The memory 115 (e.g., Random Access Memory (RAM) or another dynamic storage device) connected to the bus 105 stores information and instructions to be executed by the processor 110. The memory 115 may be used to store temporary variables or other pieces of intermediate information that are used while the processor 110 is executing an instruction.

The ROM 120 connected to the bus 105 may also store static information and instructions that are used by the processor 110.

The computing device 100 also includes the communication interface 125 connected to the bus 105. The communication interface 125 provides bidirectional data communication for connecting the computing device 100 with another computing device via a network 160. For example, the communication interface 125 may be an Integrated Services Digital Network (ISDN) card or modem for providing a data message connection to a corresponding type of telephone line. As another example, the communication interface 125 may be a Local Area Network (LAN) card for providing a data communication connection to a compatible LAN. In all these implementations, the communication interface 145 transmits or receives electrical signals, electromagnetic signals, or optical signals that carry digital data streams representing various types of information.

The storage 130 may be a magnetic disc or an optical disc and is connected to the bus 105 to store information.

The camera 135 may include an optical sensor for capturing an image or scene of an external environment.

The display 140 displays processed data and is coupled to the computing device 100 via the bus 105. For example, the display 140 may include a Cathode Ray Tube (CRT) display, a Light-Emitting Diode (LED) display, or a Liquid Crystal Display (LCD). The display 140 may also be a touch sensitive display for detecting a user's gesture or touch input, or a capacitive touch sensitive display for detecting a user's gesture without a touch. In particular, when the display 140 is a touch sensitive display and displays an image containing at least one object according to an embodiment of the present disclosure, a user may adjust the intensity of a smell that is associated with the object and dispensed by making a predetermined gesture on the object.

The smell sensor 145 detects a smell from the external environment. In particular according to an embodiment of the present disclosure, the smell sensor 145 detects and identifies a smell of at least one object detected in a captured image of an external environment.

The smell dispenser 150 dispenses a smell. In particular, the smell dispenser 150 dispenses a smell associated with at least one object in an image stored in the computing device 100.

The input device 155 may have an English alphabet, numeric, and other keys and is coupled to the bus 105 to transmit information and command selections to the processor 110. A cursor controller is another type of a user input device for transmitting directional information and command selections to the processor 110 and for controlling movements of a cursor on the display 140. For example, the cursor controller may be a mouse, a trackball, or cursor direction keys.

Various embodiments of the present disclosure are related to use of the computing device 100 for implementing techniques described herein. In some embodiments, the computing device 100 performs the present techniques in response to the processor 110 for executing instructions stored in the memory 115. The instructions may be read into the memory 115 from another machine-readable medium (e.g., the storage 130). The processor 110 may perform the process described herein by executing the instructions.

In various embodiments, the processor 110 may include at least one processing unit for performing at least one function of the processor 110. The at least one processing unit may be a hardware circuit that is substituted by software instructions for performing particular functions or used in combination with the software instructions. The processing unit may also be called a module.

The term “machine-readable medium” as used herein refers to any medium that participates in providing data for a machine to perform specified functions. In one embodiment implemented using the computing device 100, various types of machine-readable media may participate in providing instructions to the processor 110 for execution. The machine-readable media may be volatile or non-volatile storage media. Volatile storage media include a dynamic memory such as the memory 115. Non-volatile storage media include an optical or magnetic disc such as the storage 130. All machine-readable media must be tangible so that a physical mechanism for reading instructions into a machine may detect instructions contained in the media.

For example, common types of the machine-readable media include a floppy disk, a flexible disk, a hard disk, a magnetic tape or any other magnetic medium, a CD-ROM or any other optical medium, punchcards, a papertape, any other physical medium having patterns of holes, RAM, Programmable ROM (PROM), and Erasable PROM (EPROM), FLASH-EPROM, and any other memory chip or cartridge.

In another embodiment, the machine-readable media may be transmission media including coaxial cables, copper wires, and optical fibers, or including wires having the bus 105. The transmission media may take the form of acoustic or light waves such as waves generated during radio-wave and infrared data communication. Examples of the machine-readable media may also include any medium that a mobile electronic device to be described hereinafter can read, but are not limited thereto. For example, instructions may initially be stored on a magnetic disk of a remote computer. The remote computer may load the instructions into its dynamic memory and send the instructions over a telephone line by using a modem. A modem local to the computing device 100 may receive data on the telephone line and use an infrared transmitter to convert the data into an infrared signal. An infrared detector may receive the data carried in the infrared signal, and appropriate circuitry may provide the data to the bus 105. The bus 105 sends the data to the memory 115, and the processor 110 retrieves the instructions from the memory 115 for execution. The instructions received by the memory 115 may selectively be stored on the storage 130, either before or after execution of the instructions by the processor 110. The transmission media must be tangible so that a physical mechanism for reading instructions into a machine may detect instructions contained in the transmission media.

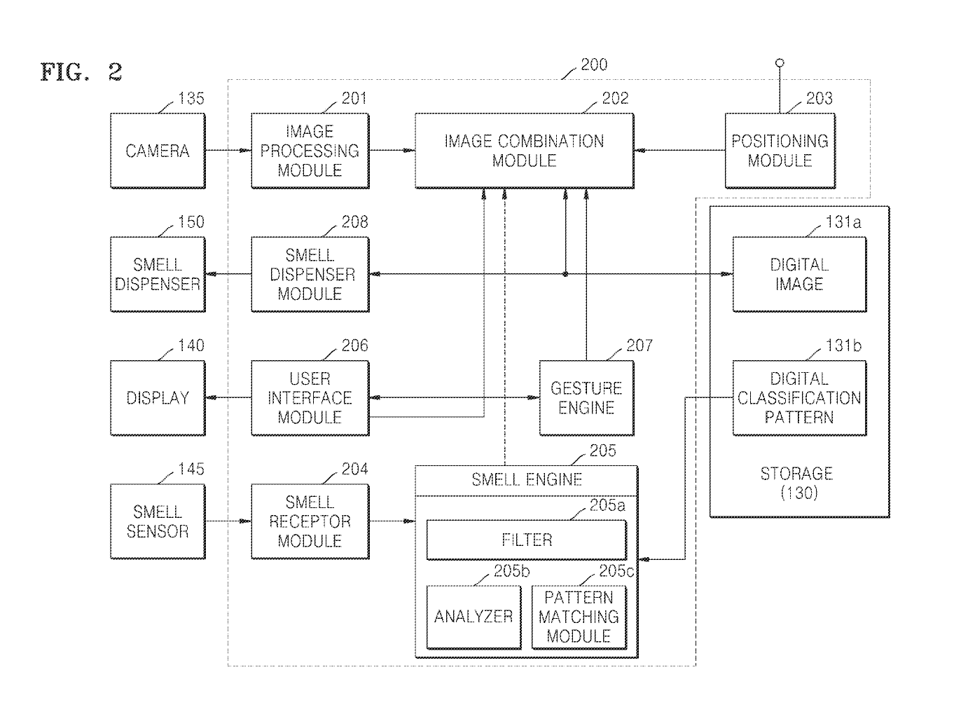

FIG. 2 is a block diagram of a module for processing at least one object in an image according to an embodiment of the present disclosure.

Referring to FIGS. 1 and 2, the module 200 may be a set of instructions that are stored in the memory 115 to be executed by the processor 110 or sub-modules in a part of or the whole module 200 may be realized by hardware.

Referring to FIG. 2, the module 200 includes an image processing module 201, an image combination module 202, a positioning module 203, a smell receptor module 204, a smell engine 205, a user interface module 206, a gesture engine 207, and a smell dispenser module 208. The module 200 may cooperate with the camera 135, the smell dispenser 150, the display 140, the smell sensor 145, and the storage 130 to process at least one object in an image along with a smell associated with the at least one object, but is not limited thereto.

The image processing module 201 receives at least one captured optical image from the camera 135, converts the received at least one optical image into at least one digital image, and transmits the at least one digital image to the image combination module 202. The image processing module 201 also detects at least one object in an image.

The positioning module 203 is configured to detect a position or geolocation of at least one object in the image by using any conventional technologies. The positioning module 203 is also configured to generate geolocation digital patterns of the detected at least one object and transmit the generated geolocation digital patterns to the image combination module 202.

The smell sensor 145 detects a smell signal associated with the detected at least one object in an image and transmits the detected smell signal to the smell receptor module 204. The smell receptor module 204 is configured to convert the received smell signal into a streamlined signal suitable for processing of the smell signal and transmit the streamlined signal to the smell engine 205.

The smell engine 205 includes a filter 205a, an analyzer 205b, and a pattern matching module 205c. The filter 205a filters noise from the streamlined signal and transmits the filtered streamlined signal to the analyzer 205b. For example, if a user having a strong perfume smell captures an image, the filter 205a in the computing device 100 may filter the user's strong perfume as the noise and then transmit only environmental smells to the analyzer 205b. The analyzer 205b is configured to analyze the intensity of the filtered streamlined signal in consideration of at least one of a flow of wind at a spot where an image is captured, a distance of objects in the image from the camera 135, presence of a strong-odor organic compound, a focal distance, and filtration of noise in a smell signal. The analyzer 205b generates a digital classification pattern representing the filtered smell signal of each of the detected objects in the image and transmits the generated digital classification pattern to the pattern matching module 205c.

The pattern matching module 205c matches the digital classification patterns received from the analyzer 205b with a set of predefined digital classification patterns stored in the storage 130 and determines a unique index assigned to each of the digital classification patterns. For example, indices of an apple smell and a grape smell may be 1000 and 1001, respectively. After determining a unique index associated with each of the digital classification patterns, the smell engine 205 transmits the determined index to the image combination module 202. The image combination module 202 is configured to combine the geolocation digital pattern of the detected at least one object with the determined index of the digital classification pattern of the smell signal and generate an image file. In this case, the determined index is stored in an Exchangeable Image File Format (EXIF) section of the generated image file. EXIF refers to the standard that specifies images, sound, and tags used by digital cameras or smartphones.

The user interface module 206 provides an image file selected by the user among stored image files to the display 140.

When an image containing an object having smell information stored therein is displayed on the display 140, the smell dispenser module 208 dispenses a smell associated with the object.

The gesture engine 207 receives gesture signals from the user and supports dispensing of smells in response to the gesture signals. For example, if an image containing a specified object having smell information stored therein is displayed on the display 140, the user may adjust the dispensing of a smell signal according to a gesture made by the user on the object.

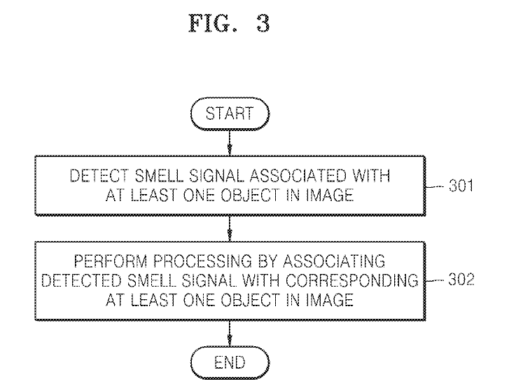

FIG. 3 illustrates a method of processing at least one object in an image according to an embodiment of the present disclosure.

Referring to FIG. 3, a smell signal associated with at least one object in a captured image is detected in operation 301. For example, the at least one object in the mage may be persons, plants, flowers, and food.

Processing is performed by associating the detected smell signal with the at least one object corresponding to the detected smell signal in the image in operation 302.

In the method according to the present embodiment, at least one object in an image is processed by associating the object with a smell signal of the object, thereby allowing a user to obtain and store visual and smell information while capturing an image, and thus enhancing an experience of the user by using a computing device.

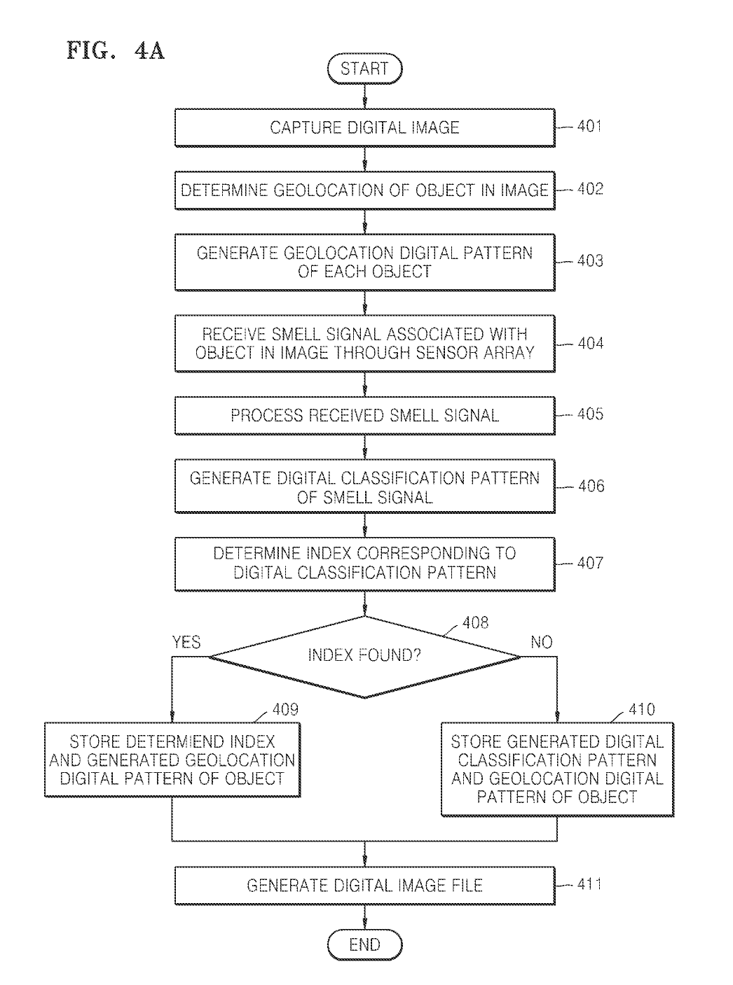

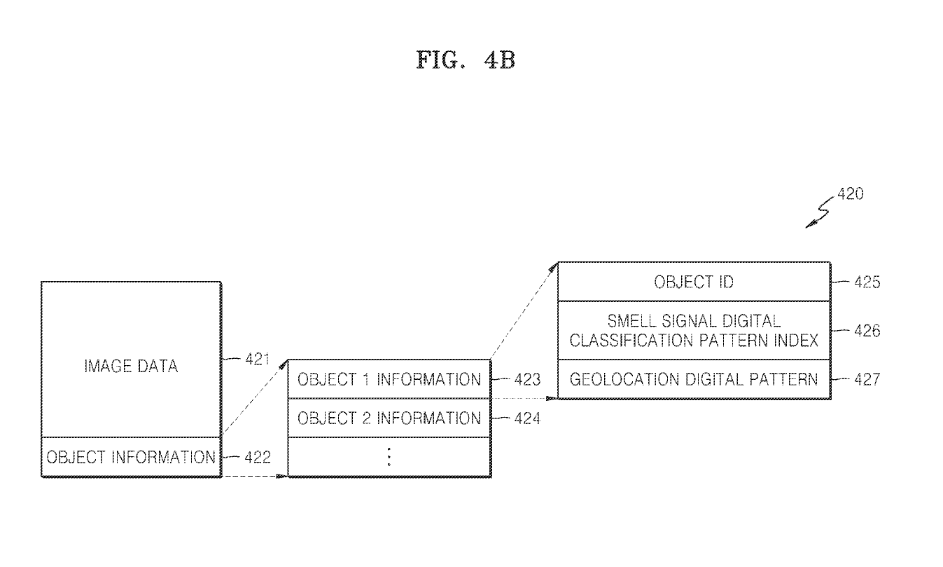

FIG. 4A illustrates a method of processing at least one object in an image according to an embodiment of the present disclosure.

Referring to FIGS. 1, 2, and 4A, a user manipulates the camera 135 that is an image capturing module in the computing device 100 to capture an image in operation 401. The captured image includes at least one object. A geolocation of the at least one object is determined by the positioning module 203 in operation 402. The geolocation of the at least one object is calculated by transmitting a signal to the object in the image from the camera 135 and measuring a focal distance.

A geolocation digital pattern corresponding to a geolocation of each object in the image is generated in operation 403.

While capturing an image, the smell sensor 145 receives a smell signal associated with at least one object in the image in operation 404.

The smell receptor module 204 and the smell engine 205 process the received smell signal in operation 405. The operation 405 includes sub-steps. First, the received smell signal is converted into a streamlined signal by the smell receptor module 204. Then, the streamlined signal is filtered by using the filter 205a, and the intensity of the filtered streamlined signal is measured by using the analyzer 205b.

Digital classification patterns of the filtered streamlined signal are generated in operation 406. Then, a matching operation is performed to determine a unique index assigned to each of the digital classification patterns in operation 407. The pattern matching module 205c matches the digital classification patterns with a set of some predefined digital classification patterns 131b stored in the storage 130 and determines a unique index assigned to each of the digital classification patterns. If the generated digital classification pattern does not match at least one of the predefined digital classification patterns 131b, i.e., if an index assigned to a corresponding digital classification pattern is not found in operation 408, a digital classification pattern corresponding to a smell signal and the generated geolocation digital pattern of each object in the captured image may be stored in operation 410. On the other hand, if the generated digital classification pattern matches the at least one of the predefined digital classification patterns 131b in operation 408, i.e., if the index assigned to a corresponding digital classification pattern is found, then the determined index and the generated geolocation digital pattern of each object in the captured image may be stored in operation 409.

The geolocation digital pattern of the at least one object in the image, which is generated in operation 403, and the index determined in operation 408 are transmitted to the image combination module 202. The image combination module 202 combines the geolocation digital pattern of the object in the image with the determined index of the digital classification pattern of the smell signal and forms a digital image file in operation 411. The determined index is stored in the EXIF section or in any standard format within the generated digital image file.

Referring to FIG. 4B, a digital image file format 420 includes image data 421 and object information 422 that is information about at least one object contained in the image data 421. The object information 422 includes object 1 information 423 about object 1 and object 2 information 424 about object 2. The object 1 information 423 includes an object IDentification (ID) 425 used to identify an object in an image, an index 426 of a digital classification pattern of a smell signal, determined in operation 408 described with reference to FIG. 4A and a geolocation digital pattern 427 generated in operation 403 described with reference to FIG. 4A. As described with reference to operation 408, if an index assigned to a digital classification pattern is not found, the object 1 information 423 may include a determined geolocation digital pattern 427 instead of the index 426.

As described with reference to operation 410 in FIG. 4A, the generated digital image file may be stored in the storage (130 in FIG. 2) as the digital image (131a in FIG. 2). Operations in the method of FIG. 4A may be performed in the same order as or a different order than illustrated in FIG. 4A, or simultaneously. In various embodiments, some of the operations illustrated in FIG. 4A may also be omitted.

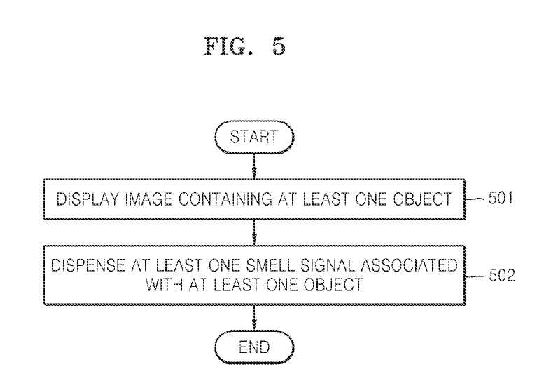

FIG. 5 is a flowchart of a method of dispensing a smell of an object in an image according to an embodiment of the present disclosure.

Referring to FIG. 5, an image containing at least one object is displayed in operation 501.

At least one smell signal associated with the at least one object is dispensed in operation 502.

According to the present embodiment, when viewing an image stored in a computing device, the user may not only see the image with the eyes but also smell an object in the image, thus enhancing user experience through sensing, by using the computing device.

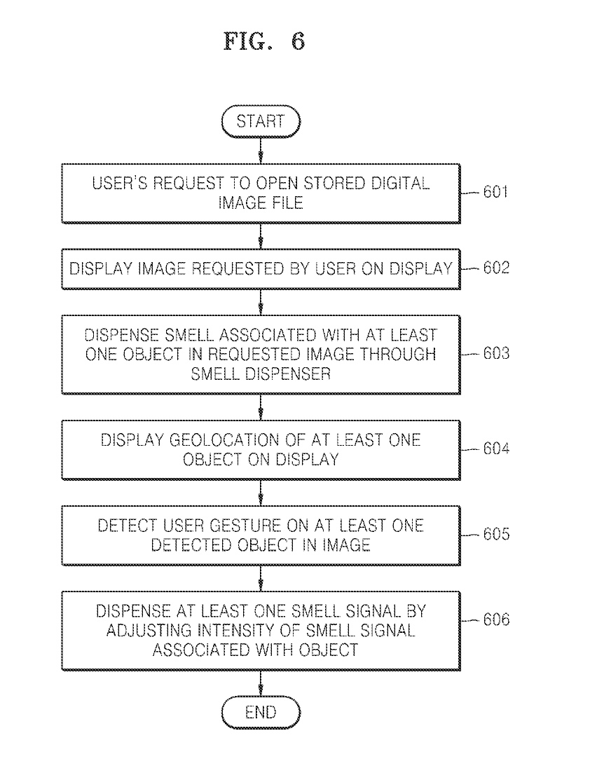

FIG. 6 is a flowchart of a method of viewing a stored captured image and dispensing a smell of an object in the captured image according to an embodiment of the present disclosure.

Referring to FIGS. 1, 2, and 6, a user requests opening of a stored digital image file 131a in operation 601.

The computing device receives such a request, and the user interface module 206 displays an image requested by a user on the display 140 in operation 602. The smell dispenser module 208 dispenses a smell associated with at least one object in the requested image through the smell dispenser 150 in operation 603.

The method also allows the user to view a geolocation of the at least one object on the display 140 in operation 604.

When a user gesture is detected for the at least one object in the image in operation 605, at least one smell signal associated with the object is dispensed by adjusting the intensity of the at least one smell signal in operation 606. In detail, the gesture engine 207 receives a user gesture input through the user interface module 206, and the smell dispenser module 208 adjusts the intensity of a smell signal dispensed by the smell dispenser 150 in response to the user gesture.

Examples of the user gesture include zooming in on a particular object in the image to increase emission of a smell of the object, zooming out on a particular object in the image to decrease emission of a smell of the object, zooming in the image abruptly to increase a collective smell of objects in focus, zooming out the image abruptly to decrease a collective smell of objects in focus, tapping on a particular object in the image with the fingers to increase emission of a smell of the object, tapping on a particular object in the image with the fingers to decrease emission of a smell of the object, touching multiple objects in the image to generate a multi-geolocation object environment smell, a swipe up gesture on a particular object to increase emission of a smell of the object, and a swipe out gesture on a particular object to decrease emission of a smell of the object.

Various operations in the method of FIG. 6 may be performed in the same order as or a different order than illustrated in FIG. 6, or simultaneously. Further, in various embodiments, some of the operations illustrated in FIG. 6 may be omitted.

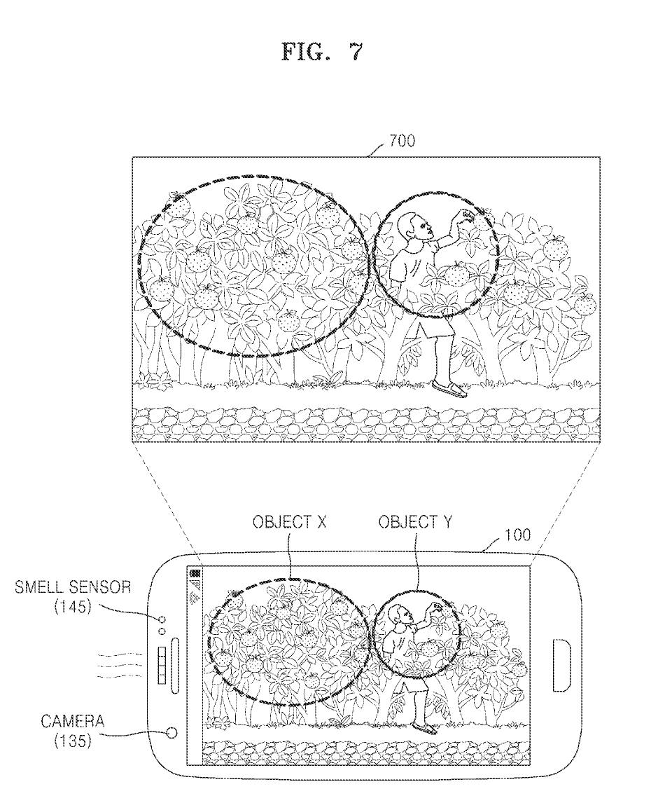

FIG. 7 illustrates a method of incorporating a smell of at least one object in an image and a geolocation corresponding to an associated object into the image while capturing the image according to an embodiment of the present disclosure.

Referring to FIG. 7, a user operates a computing device 100 that provides an object geolocation detection capability and includes a smell sensor 145 for sensing a smell signal associated with an object. As shown in FIG. 7, the computing device 100 also includes a camera 135 that captures a scene or an image 700 having object X and an object Y. Reference geolocation information of the device 100 and geolocation information of the object X and the object Y are determined by the positioning module 203 in FIG. 2.

After receiving smells associated with the object X and the object Y through the smell sensor 145, the device 100 determines digital classification patterns of the smells associated with the object X and the object Y and performs matching with a set of some predefined digital patterns to find unique indices corresponding to the determined digital classification patterns. The unique indices of both the object X and object Y are transmitted to the image combination module 202 in FIG. 2 along with geolocation digital patterns of the object X and object Y. The image combination module 202 generates an image file including geolocation information of the object X and the object Y, and the generated image is stored in the storage 130 in FIG. 2.

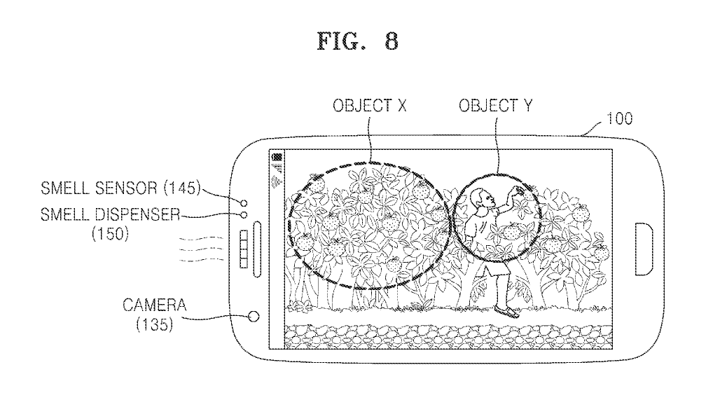

FIG. 8 illustrates a method of displaying the captured image shown in FIG. 7 and dispensing a smell of an object associated with the captured image according to an embodiment of the present disclosure.

Referring to FIG. 8, if the user desires to view the stored image file including the object X and the object Y, the device 100 displays the image file on the user interface module 206 in FIG. 2 and dispenses smell signals associated with the object X and the object Y in the image file through a smell dispenser 150 Thus, the user may have visual and olfactory experiences from an image so that the user experiences the same sensation as when capturing an image.

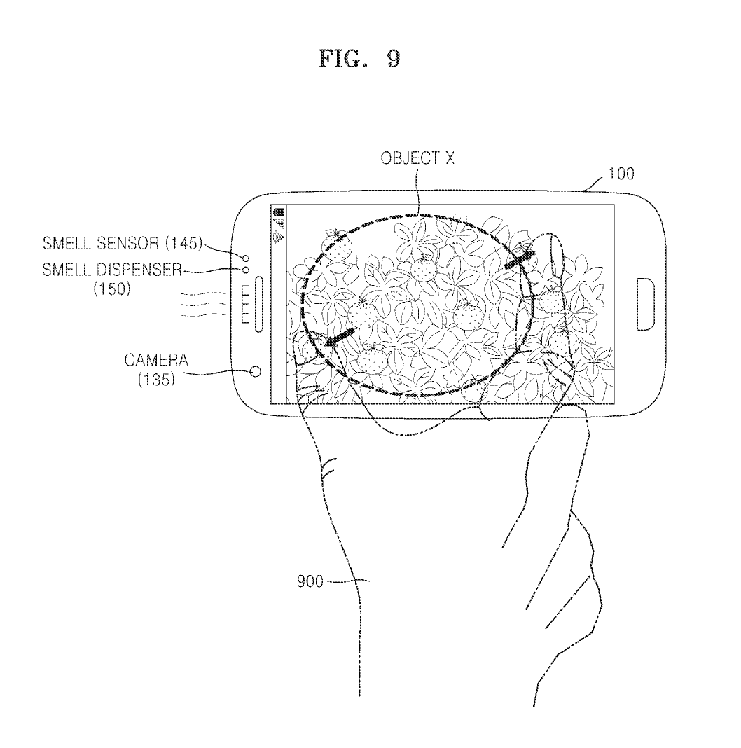

FIG. 9 illustrates a method of viewing a captured image and dispensing a smell of an object associated with the captured image based on a user's gesture according to an embodiment of the present disclosure.

Referring to FIG. 9, when a user 900 makes a zoom-in gesture on the object X in the image displayed on the device 100 shown in FIG. 8, e.g., a touch sensitive display, the touch sensitive display of the device 100 detects the user gesture. The gesture engine 207 in FIG. 2 then receives the user gesture detected by the touch sensitive display, i.e., zoom-in operation, and supports dispensing of a smell of an object according to the received user gesture. In other words, in response to the user gesture, the device 100 increases a smell associated with the object X while diminishing a smell associated with the object Y.

A method and device for incorporating a smell of a geolocation object into an image according to various embodiments of the present disclosure allow fast, simple, and efficient incorporation of the smell of the geolocation object into the image along with sound (audio) and vision (video), thereby enhancing user experience while viewing the image.

The various embodiments disclosed herein may be implemented through at least one software program that is run on at least one hardware device and performs network management functions for controlling elements. The elements shown in the accompanying drawings include blocks which may be at least one of a hardware device or a combination of a hardware device and a software module.

A method of operating a photoacoustic apparatus according to an embodiment of the present disclosure may be embodied as a computer-readable code on a computer-readable storage medium. The computer-readable storage medium is any data storage device that can store data which can be thereafter read by a computer system. Examples of computer-readable storage media include ROM, RAM, CD-ROMs, magnetic tapes, floppy disks, and optical data storage devices. The computer-readable storage media can also be distributed over a network-coupled computer system so that computer-readable codes are stored and executed in a distributed fashion.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of processing at least one object in an image in a computing device, the method comprising:
detecting at least one smell signal associated with the at least one object in the image; and
performing processing by associating the detected at least one smell signal with the at least one object in the image.

2. The method of claim 1, wherein the detecting of the at least one smell signal associated with the at least one object in the image comprises:
detecting the at least one object in the image; and
receiving the at least one smell signal associated with the detected at least one object through a sensor.

3. The method of claim 1, wherein the performing of the processing comprises:
converting the at least one smell signal into at least one streamlined signal;
filtering the at least one streamlined signal and analyzing an intensity of the filtered at least one streamlined signal; and
generating a digital classification pattern of the at least one smell signal based on the intensity of the filtered at least one streamlined signal.

4. The method of claim 3, wherein the performing of the processing further comprises determining an index associated with the generated digital classification pattern by mapping the generated digital classification pattern to a predefined digital classification pattern.

5. The method of claim 4, wherein the performing of the processing further comprises generating a geolocation digital pattern corresponding to a geolocation of the at least one object in the image.

6. The method of claim 5, further comprising generating a digital image file by combining the generated geolocation digital pattern corresponding to a geolocation of the at least one object with the index associated with the generated digital classification pattern of the at least one smell signal.

7. A method of processing at least one object in an image in a computing device, the method comprising:
displaying the image containing the at least one object; and
dispensing at least one smell signal associated with the at least one object.

8. The method of claim 7, further comprising:
detecting a user gesture on the at least one object; and
adjusting the dispensing of the at least one smell signal associated with the at least one object in response to the detection of the user gesture.

9. The method of claim 7, further comprising displaying geolocation information associated with the at least one object.

10. A computing device comprising:
a display;
a sensor configured to receive at least one smell signal;
a memory configure to store at least one instruction; and
a processor configured to execute the at least one instruction stored in the memory,
wherein the processor, in response to the at least one instruction stored in the memory, is further configured to detect the at least one smell signal associated with at least one object in an image and to perform processing by associating the detected at least one smell signal with the at least one object in the image.

11. The computing device of claim 10, wherein, in order to detect the at least one smell signal associated with the at least one object in the image in response to the at least one instruction, the processor is further configured to detect the at least one object in the image and to receive the at least one smell signal associated with the detected at least one object in the image through a sensor.

12. The computing device of claim 10, wherein, in order to perform the processing by associating the detected at least one smell signal with the at least one object in the image in response to the at least one instruction, the processor is further configured to convert the at least one smell signal into at least one streamlined signal, to filter the at least one streamlined signal and to analyze an intensity of the filtered at least one streamlined signal, and to generate a digital classification pattern of the at least one smell signal based on the intensity of the filtered streamlined signal.

13. The computing device of claim 12, wherein, in response to the at least one instruction, the processor is further configured to determine an index associated with the generated digital classification pattern by mapping the generated digital classification pattern to a predefined digital classification pattern.

14. The computing device of claim 13, wherein, in order to perform the processing by associating the detected at least one smell signal with the at least one object in the image in response to the at least one instruction, the processor is further configured to generate a geolocation digital pattern corresponding to a geolocation of the at least one object in the image.

15. The computing device of claim 14, wherein, in response to the at least one instruction, the processor is further configured to generate a digital image file by combining the generated geolocation digital pattern of the at least one object with the index associated with the generated digital classification pattern of the at least one smell signal.

16. A computing device comprising:
a display;
a smell dispenser configured to dispense a smell signal;
a memory configured to store at least one instruction; and
a processor configured to execute the at least one instruction stored in the memory,
wherein, in response to the at least one instruction, the processor is further configured to display an image containing at least one object and to dispense at least one smell signal associated with the at least one object.

17. The computing device of claim 16, wherein, in response to the at least one instruction, the processor is further configured to detect a user gesture on the at least one object and to adjust dispensing of the at least one smell signal associated with the at least one object in response to the detection of the user gesture.

18. The computing device of claim 16, wherein, in response to the at least one instruction, the processor is further configured to display geolocation information associated with the at least one object.

19. The computing device of claim 18, wherein the processor is further configured to generate a geolocation digital pattern corresponding to a geolocation of the at least one object.

20. A non-transitory computer-readable recording medium having recorded thereon a program for executing a method of processing at least one object in an image in a computing device on a computer, the method comprising:
detecting at least one smell signal associated with the at least one object in the image; and
performing processing by associating the detected at least one smell signal with the at least one object in the image.
